(19) United States
(12) Patent Application Publication
(10) Pub. No.: US 2020/0407585 A1
(43) Pub. Date: Dec. 31, 2020

(54) COATING COMPOSITION, IN PARTICULAR FOR PRODUCING A COATED WALL, FLOOR OR CEILING COVERING, IN PARTICULAR FOR PRODUCING COATED WALLPAPER

(71) Applicant: Follmann GmbH & Co. KG, Minden (DE)

(72) Inventors: Hans-Jürgen BÖSE, Steyerberg (DE); Bernd GEISEL, Minden (DE); Harald KLIMPKE, Petershagen (DE); Elke KRÖGER, Rahden (DE); Christoph PETTER, Bückeburg (DE); Annika RETHMEIER, Petershagen (DE)

(73) Assignee: Follmann GmbH & Co. KG, Minden (DE)

(21) Appl. No.: 16/753,968

(22) PCT Filed: Oct. 9, 2018
(86) PCT No.: PCT/EP2018/077481

§ 371 Date: Apr. 6, 2020

(30) Foreign Application Priority Data
Oct. 9, 2017 (DE) 20 2017 005 179.6

(51) Int. Cl. C09D 131/04; B32B 27/10; C09D 7/65; C08K 5/20; C08L 31/04; C08K 3/26; B32B 29/00; B32B 27/30; C09D 7/61; C08L 23/06

(52) U.S. Cl. CPC C09D 131/04; B32B 27/10; C09D 7/65; C08K 5/20; C08L 31/04; C08K 3/26; B32B 2255/26; B32B 27/306; C09D 7/61; C08L 23/06; C08K 2003/267; B32B 2255/12; C08K 2003/265; B32B 29/007

(57) ABSTRACT

The present invention relates to a coating composition for the production of a coated substrate and, in particular, for the production of a coated wall, floor and ceiling covering.

The present invention relates to a coating composition for the production of a coated substrate, in particular, for the production of a coated wall, floor and ceiling covering, such as, for example, for the production of a coated wallpaper. In addition, the present invention relates to a substrate, coated with the coating composition, in particular, a coated wall, floor and ceiling covering, such as a coated wallpaper. Similarly, the invention also relates to a method for producing a coated substrate and, in particular, a coated wall, floor and ceiling covering.

The substrate, coated in accordance with the invention, is characterized, in particular, by an improved flatness as well as attachability with at the same time good printability and em bossability.

Coated wall, floor and ceiling coverings are used in almost all public and private buildings. While the primary purpose of the coating, usually a polymer coating, on a floor covering is to increase the wear resistance and to adjust the slip resistance of the floor covering, the purpose of the polymer coating on a wall covering (such as wallpaper) is to ensure, among other things, good printability and ease of maintenance. Very popular is wallpaper that is coated with polyvinyl chloride (PVC) and that is often used as wall covering in hotel rooms, bathrooms, showers, corridors, stairwells, kitchens, children's rooms, schools, offices and government offices due to its excellent ease of care and high flammability resistance. Even considerable amounts of dirt can be easily removed from coated wallpaper of this type with brushes and water or mild soapy water. Another prominent area of application for PVC is structural foam wallpaper, on which relief-like surfaces can be formed and that gives a spatial dimension to the patterns that are reproduced on the surface.

However, wall, floor and ceiling coverings, such as wallpaper, containing PVC or, more specifically, coated with PVC, have significant drawbacks. Over time the chlorine-containing polymer PVC releases hydrogen chloride gas and, in the event of a fire, forms highly toxic dioxins, which is the reason that PVC coated wall, floor and ceiling coverings present a potential risk to the health of the occupants. Furthermore, due to the fact that the PVC containing wallpaper has a lower rate of water vapor transmission than paper wallpaper, said PVC containing wallpaper has an adverse effect on the indoor climate, so that said PVC wallpaper requires frequent and good ventilation of those rooms that are lined with such wallpaper. Especially in energy-optimized buildings, the PVC containing wallpaper may raise a health concern because of the high concentrations of pollutants caused by the air change, which is set at 0.5 times an hour in accordance with the standard, and the absence of ventilation by means of windows.

For the aforementioned reasons, attempts have been made in recent years to replace the PVC coatings on wall, floor and ceiling coverings with polymer coatings that are characterized by compounds that are less of a health concern as a result of a lower level of emission as well as because of fewer adverse effects on the indoor climate; and in the event of a fire said polymer coatings do not produce any combustion products or at least produce combustion products that are less toxic.

The document DE 41 20 306 A1 describes a method for producing a structural foam wallpaper, in which method a heated thermoplastic is applied as an adhesive to a paper substrate web that in turn is coated with a foam of the same type, and then the foam is provided with the desired

surface structure by means of an embossing roller. The thermoplastic that is proposed in said document is, in particular, polyethylene, polypropylene, polystyrene and polyester, i.e., polymers that do not contain any harmful halogens or other incompatible substances. However, the drawback with these wallpapers is that they have a very strong tendency to curl or rather to peel or alternatively to roll up in the direction of the coating, an aspect that makes it difficult or even impossible to attach it to the wall. This is true, especially if the wallpaper is attached using a wall adhesion technique, where in a first step paste is applied to the wall in strips and in a uniform manner with a roller or brush, before the wallpaper is applied and pressed on said paste with, for example, a clean cloth, a soft roller or a brush. This technique allows wall coverings to be attached to a wall easily and quickly, but requires a flat wall covering that remains flat even after it has been attached to the paste. With this technique curling or peeling wallpaper cannot be attached to walls or at least not with the desired result.

The document DE 195 30 508 A1 discloses a wallpaper with a visible side layer made of polyethylene non-woven fabric. The polyethylene non-woven fabric consists of a thermomechanically bonded non-woven fabric made of continuous polyethylene (PE) fibers and exhibits bilaterally high strength in both the dry and wet state and cannot be torn apart under normal stress. However, wallpaper of this type is disadvantageous in so far as that only a few options are available for forming the surface of the wallpaper in a design. In addition, the fibrous surface means that it is not possible to produce fine structures with an embossing apparatus. In addition, the combination of paper having a very high swelling capacity and a high-strength, non-swelling PE non-woven fabric leads to a considerable degree of curling, so that the wallpaper cannot be processed using the wall adhesion technique or only with an unsatisfactory result.

The document DE 86 00 174 U1 describes a wallpaper with a backing layer made of paper and a visible side layer made of polyethylene, where the backing layer is made up of several layers of paper and has a specific weight per unit area of from 180 to 230 grams per square meter; and the visible side layer of polyethylene has a specific weight per unit area of at least 15 grams per square meter. However, even this wallpaper is not suitable for processing using the wall adhesion technique, since it curls to high degrees.

The document DE 26 59 192 A1 proposes a printed wallpaper that consists of a paper backing and a washable coating, with the coating being made of a transparent polyolefin. This wallpaper, too, is not suitable for attaching to a wall using the wall adhesion technique, since the polyolefin crystallizes to high degrees and shrinks during the cooling process, for which reason the wallpaper is characterized by high degrees of curling.

The object of the present invention is to make available a coating composition that is suitable, in particular, for coating a web-shaped substrate and, in particular, for producing a flexible wall, floor or ceiling covering in the shape of a roll in such a way that said coating composition improves or avoids at the very least the problems mentioned above.

In particular, it is desirable that the wall, floor or ceiling covering, which is coated with the coating composition, can also be processed as flatly as possible using an adhesion technique and without curling or at least without any significant degree of curling. In addition, it is also advantageous that it can be printed with conventional colors to the greatest extent possible.

An additional challenge is that the coating composition that can be used to produce a wall, floor or ceiling covering does not release, as far as possible, any or hardly any potentially hazardous compounds that could have an adverse effect on the indoor climate; and/or in the event of a fire said coating composition does not generate any combustion products or at the very least generates combustion products that are less toxic.

In accordance with the invention, the object is achieved by making available a coating composition for the production of a coated substrate and, in particular, for the production of a coated wall, floor and ceiling covering, said coating composition containing:

a) 15 to 80% by weight of at least one ethylene vinyl acetate copolymer,
b) 0.1 to 30% by weight of at least one hydrocarbon resin,
c) 0.1 to 20% by weight of at least one wax,
d) 0.1 to 80% by weight of at least one filler,
e) 0.01 to 20% by weight of at least one lubricant that is selected from the group consisting of carboxylic acid amides, fatty alcohols, metal soaps, complex esters and any mixture of two or more of the aforementioned compounds, and
f) 0.0 to 10% by weight of optionally a blowing agent, where the sum of all the components of the composition is 100% by weight.

The coating composition can also be obtained by combining
a) 15 to 80% by weight of at least one ethylene vinyl acetate copolymer,
b) 0.1 to 30% by weight of at least one hydrocarbon resin,
c) 0.1 to 20% by weight of at least one wax,
d) 0.1 to 80% by weight of at least one filler,
e) 0.01 to 20% by weight of at least one lubricant that is selected from the group consisting of carboxylic acid amides, fatty alcohols, metal soaps, complex esters and any mixture of two or more of the aforementioned compounds, and
f) 0.0 to 10% by weight of optionally a blowing agent, where the sum of all the components of the composition is 100% by weight.

In accordance with the invention, the sum of all the components of the coating composition is 100% by weight. To the extent that the coating composition consists of the components a) to f), the sum of the components a) to f) is, therefore, 100% by weight. To the extent that the coating composition contains, in addition to the components a) to f), additional components, such as, for example, the additives h) and i), then the sum of the components a) to i) is 100% by weight.

This solution is based on the knowledge that the aforementioned combination of ethylene vinyl acetate copolymer, hydrocarbon resin, wax and lubricant gives a coating composition that after coating a corresponding web-shaped substrate, such as a paper wallpaper, leads to a coated substrate with particularly advantageous properties. These properties are primarily the surface strength and the abrasion resistance as well as the hardness and the thermal stability, in addition, also printability and processability.

In particular, the corresponding coated substrates exhibit excellent printability with standard printing inks and, in particular, aqueous printing inks by means of the conventional printing processes, such as gravure, flexographic, inkjet and screen printing processes.

A special feature of the coating composition of the present invention is its low degree of tackiness and short “open time”. Usually these properties are indications of a very crystalline material. However, the coating of the present invention has a surprisingly low degree of crystallization. This aspect offers advantages in the coating process and also in conjunction with conventional printing processes. In the course of cooling or, more specifically, solidifying on the substrate, a highly crystalline material will shrink and, in so doing, will cause the coating to curl. Therefore, the ability to process by machine would no longer be ensured.

Due to the low degree of crystallization and the resulting flatness, the substrates, coated with the coating composition of the present invention, can also be attached using an adhesion technique (where, for example, in a first step the paste is applied in strips and in a uniform manner to the floor, the wall or the ceiling with a roller or a brush before the wall, floor or ceiling covering is affixed to said paste and then pressed onto said paste, for example, with a clean cloth, a soft roller or a brush) to the floor, wall or ceiling flatly and without any curling or at least without any significant degree of curling. Therefore, in particular, wallpaper, coated with the coating composition of the present invention, can be attached flatly to a wall in an easy and reliable way using the wall adhesion technique.

The coating composition of the present invention is also suitable, in particular, for the production of structural foam wallpaper. Furthermore, the coating composition of the present invention does not release any compounds that are hazardous to health and, in particular, does not release any halogen-containing compounds, since the coating composition of the present invention does not require the addition of halogen-containing compounds, such as PVC, or polymers, which release other compounds that present a health risk.

In addition, the coating composition of the present invention exhibits a sufficient rate of water vapor transmission, so that a substrate, which is coated with the coating composition of the present invention, has no adverse effect on the indoor climate. Finally, in the event of a fire the coating composition of the present invention does not produce, on account of its composition, any combustion products or at least produces combustion products that are less toxic.

For the purpose of the present invention a hydrocarbon resin is defined as a compound containing carbon and hydrogen and having a weighted average molecular weight of from 100 to 10,000 g/mol. At least 90% and more preferably at least 95% of the compound are preferably carbon and hydrogen atoms, whereas the rest can be heteroatoms, such as, for example, nitrogen or oxygen atoms. The weighted average molecular weight of the hydrocarbon resin is preferably 100 to 3,000 g/mol.

The hydrocarbon resin is selected preferably from the following group: aliphatic resins, cycloaliphatic resins, indene-coumarone resins, polystyrene resins, poly methyl styrene resins and any mixture of two or more of the aforementioned compounds.

The resin is selected, in particular, preferably from the following group: cycloaliphatic resin, indene-coumarone resin and/or a poly methyl styrene resin. More preference is given to a dicyclopentadiene resin, an indene-coumarone resin and/or a poly alpha methyl styrene resin or mixtures thereof.

Even more highly preferred is an indene-coumarone resin or a dicyclopentadiene resin having a weighted average molecular weight of from 200 to 1,000 g/mol and/or a poly alpha methyl styrene resin having a weighted average molecular weight of from 500 to 2,000 g/mol. The most preferred embodiment is an indene-coumarone resin. The latter is a polymerization product that is well-known to a person skilled in the art and is made up of coumarone and indene and related compounds. This product is often used in painting and coating technology.

The function of the hydrocarbon resin is, in particular, that of a plasticizer and/or a polymer modifier. In particular, it can also improve the adhesion and, as a result, perform the function of an adhesion promoter.

In this case the word “resin” does not have a meaning that extends beyond the above definition, i.e., the defined molecular weight and the atomic composition.

In accordance with the present invention the coating composition contains 0.01 to 20% by weight of at least one lubricant that is selected from the group consisting of carboxylic acid amides, cetyl and stearyl alcohols, metal soaps, complex esters and any mixture of two or more of the aforementioned compounds. The addition of the lubricant leads to a decrease in the tackiness of the coating composition and helps, along with the ethylene vinyl acetate copolymer, the hydrocarbon resin and the wax, to prevent a substrate, coated with the coating composition, from curling.

In this case good results are obtained, especially if the at least one lubricant is a carboxylic acid amide of the general formula (I) and/or a salt thereof,

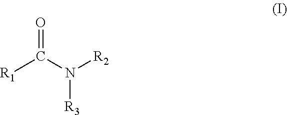

where
R₁ is a substituted or unsubstituted, straight-chain or branched alkyl group, a substituted or unsubstituted, straight-chain or branched alkenyl group, a substituted or unsubstituted, straight-chain or branched alkynyl group, a substituted or unsubstituted cycloaliphatic group, a substituted or unsubstituted aromatic group, a substituted or unsubstituted heterocyclic group, a substituted or unsubstituted alkoxy group, a substituted or unsubstituted alkoxy carbonyl group, a substituted or unsubstituted carboxyl group or a substituted or unsubstituted alkyl amide group; and
R₂ and R₃ are the same or different from each other and denote hydrogen, a substituted or unsubstituted, straight-chain or branched alkyl group, a substituted or unsubstituted, straight-chain or branched alkenyl group, a substituted or unsubstituted, straight-chain or branched alkynyl group, a substituted or unsubstituted cycloaliphatic group, a substituted or unsubstituted aromatic group, a substituted or unsubstituted heterocyclic group, a substituted or unsubstituted alkoxy group, a substituted or unsubstituted alkoxy carbonyl group, a substituted or unsubstituted carboxyl group or a substituted or unsubstituted alkyl amide group.

A carboxylic acid amide of the general formula (I) and/or a salt thereof is/are added, in particular, preferably to the coating composition as a lubricant, where R₁ is a substituted or unsubstituted, straight-chain or branched C₁₋₂₅ alkyl group, a substituted or unsubstituted, straight-chain or branched C₁₋₂₅ alkenyl group, a substituted or unsubstituted, straight-chain or branched C₁₋₂₅ alkynyl group, a substituted or unsubstituted C₆₋₂₀ cycloaliphatic group, a substituted or unsubstituted C₆₋₂₀ aromatic group, a substituted or unsubstituted C₁₋₂₀ heterocyclic group, a substituted or unsubstituted C₁₋₂₅ alkoxy group, a substituted or unsubstituted C₁₋₂₅ alkoxy carbonyl group, a substituted or unsubstituted carboxyl group or a substituted or unsubstituted alkyl amide group; and R₂ and R₃ are the same or different from each other and denote hydrogen, a substituted or unsubstituted, straight-chain or branched C₁₋₂₀ alkyl group, a substituted or unsubstituted, straight-chain or branched C₁₋₂₀ alkenyl group, a substituted or unsubstituted, straight-chain or branched C₁₋₂₀ alkynyl group, a substituted or unsubstituted C₆₋₂₀ cycloaliphatic group, a substituted or unsubstituted C₆₋₂₀ aromatic group, a substituted or unsubstituted C₁₋₂₀ heterocyclic group, a substituted or unsubstituted C₁₋₂₀ alkoxy group, a substituted or unsubstituted C₁₋₂₀ alkoxy carbonyl group, a substituted or unsubstituted carboxyl group or a substituted or unsubstituted alkyl amide group.

Good results with respect to a low degree of tackiness of the coating composition are obtained, especially if a carboxylic acid amide of the general formula (I) and/or a salt thereof is/are added to the coating composition as a lubricant, where

R₁ is a straight-chain or branched C₁₋₂₅ alkyl group, a straight-chain or branched C₁₋₂₅ alkenyl group, a straight-chain or branched C₁₋₂₅ alkynyl group, a C₆₋₂₀ cycloaliphatic group or a C₆₋₂₀ aromatic group; and R₂ and R₃ are the same or different from each other and denote hydrogen, a straight-chain or branched C₁₋₂₅ alkyl group, a straight-chain or branched C₁₋₂₅ alkenyl group, a straight-chain or branched C₁₋₂₅ alkynyl group, a C₆₋₂₀ cycloaliphatic group or a C₆₋₂₀ aromatic group.

In order to achieve a particularly low degree of tackiness of the coating composition, it is proposed in a further development of the invention to add a carboxylic acid amide of the general formula (I) and/or a salt thereof to the coating composition as a lubricant, where R₁ is a C₁₀₋₂₄ alkyl group; and R₂ and R₃ are the same or different from each other and denote hydrogen or a substituted or unsubstituted alkyl amide group.

The coating composition contains, in particular, preferably a carboxylic acid amide of the general formula (I) and/or a salt thereof as a lubricant, where R₁ is a C₁₀₋₂₄ alkyl group and preferably a C₁₅₋₂₀ alkyl group; and R₂ denotes a substituted or unsubstituted alkyl amide group; and R₃ denotes a hydrogen.

Secondary amides and most preferably octadecanamide and the salts thereof are a very highly preferred example of a suitable lubricant.

However, other lubricants are also possible, such as, for example, in particular, metal soaps, complex esters and fatty alcohols. In accordance with the present invention, metal soaps are salts of fatty acids as well as salts of resin acid and naphthenic acids with metals.

Preference is given to metal soaps of C2 to C30 mono- and/or dicarboxylic acids, preferably C12 to C20 mono- and/or dicarboxylic acids, in particular, preferably stearic acid, sebacic acid, adipic acid and azelaic acid or mixtures thereof. Substituted mono- and/or dicarboxylic acid derivatives, in particular, stearic acid derivatives and/or sebacic acid derivatives are also possible. Mono- and/or dicarboxylic acids are selected, in particular, preferably from the group consisting of: hydroxy stearic acids and/or hydroxy stearic acid derivatives, hydroxy sebacic acids and/or hydroxy sebacic acid derivatives, in particular, from 12-hydroxy stearic acid.

The cations of the metal soaps are preferably from the group consisting of: Li, Na, K, Ca, Ba, Al and/or Zn, in particular, preferably from the group consisting of Zn, Li, Na, K and Ca. A very highly preferred metal soap is zinc stearate.

Potassium and/or sodium salts of terpene acids or naphthenic acids with metals are also preferred.

To the extent that the metal soap contains two different metal ions, such as, for example, sodium and potassium ions, they are also referred to as mixed metal soaps.

In accordance with the present invention, complex ester is understood to mean a reaction product of polyols and monocarboxylic acids and dicarboxylic acids, a reaction product of polyols and monoalcohols and dicarboxylic acids or a reaction product of polyols and monoalcohols and monocarboxylic acids and dicarboxylic acids.

Suitable examples of complex esters include reaction products of polyols and C₁₋₂₀ monocarboxylic acids and C₁₋₂₀ dicarboxylic acids, preferably reaction products of polyols and C₁₋₂₅ monocarboxylic acids and C₁₋₂₅ dicarboxylic acids and, in particular, preferably reaction products of polyols and C₅₋₂₅ monocarboxylic acids and C₅₋₂₅ dicarboxylic acids. Preferred polyols are pentaerythritol, glycerol, propylene glycol, ethylene glycol, xylitol, polyether polyols and the like. Particularly preferred complex esters are neopolyol esters.

In accordance with the present invention, the fatty alcohols are aliphatic, long-chain monohydric alcohols. The hydrocarbon radicals are often unbranched in native fatty alcohols; synthetic fatty alcohols can also be branched. Fatty alcohols having 6 to 22 carbon atoms are preferred in accordance with the invention. Stearyl alcohol (1-octadecanol) and cetyl alcohol (1-hexadecanol) are particularly preferred.

In accordance with the present invention, a wax is defined as a substance that is kneadable, solid to brittle and hard at 20° C., has a coarse to finely crystalline structure, is translucent to opaque with coloring, but not vitreous, melts above 40° C. without decomposition, flows readily (i.e., relatively low viscosity) a little above the melting point, has a highly temperature-dependent consistency and solubility and can be polished under light pressure.

In accordance with the present invention, the waxes are selected preferably from the group consisting of: polyolefin wax (in particular, polyethylene wax), paraffins, Fischer-Tropsch waxes, montan waxes/ester waxes, amide waxes, natural waxes and PTFE (polytetrafluoroethylene) or mixtures thereof. These groups of compounds are well-known to those skilled in the art.

Special preference is given to polyolefin waxes, in particular, polyethylene waxes. Polyethylene waxes (PE waxes) are produced by polymerizing the gaseous substance ethylene or by thermal degradation of high molecular plastics.

It is particularly preferred that the at least one wax is a polyolefin wax, more preferably a polyethylene wax and most preferably a polyethylene wax having a weighted average molecular weight of from 500 to 2,000 g/mol. Furthermore, it is also preferred to provide a corresponding wax with a low residual monomer content in the coating composition, that is to say, preferably a wax with a corresponding residual monomer content of less than 1,000 ppm, more preferably of less than 100 ppm and most preferably of not more than 10 ppm. This feature helps to prevent the emission of undesirable substances and unpleasant odors.

The proportion of the lubricant in the coating composition is preferably 0.025 to 10% by weight. Smaller amounts of lubricant lead to an insufficient reduction in the tackiness of the coating composition, whereas higher amounts do not bring about a further reduction in the tackiness, but rather have an adverse impact on the application properties of the coating composition. In view of the aforesaid, it is also preferred that the proportion of the lubricant in the coating composition is 0.05 to 5% by weight, more preferably 0.1 to 2% by weight and most preferably 0.2 to 1.5% by weight.

In accordance with the present invention, the coating composition contains 15 to 80% by weight of at least one ethylene vinyl acetate copolymer. The addition of the ethylene vinyl acetate copolymer contributes significantly to a suitable viscosity of the coating composition and, in combination with the lubricant, the hydrocarbon resin and the wax, to a reduction in the degree of curling of the substrate that is coated with said coating composition.

In this respect good results are obtained, especially if the at least one ethyl vinyl acetate copolymer of the coating composition is a copolymer that does not contain, apart from the comonomers ethene and vinyl acetate, any other comonomer. Furthermore, it is preferred that the coating composition has a low residual monomer content of ethylene and vinyl acetate, i.e., preferably a corresponding residual monomer content of less than 1,000 ppm, more preferably of less than 100 ppm and most preferably of not more than 10 ppm. This feature helps to prevent the emission of undesirable substances and unpleasant odors.

In a further development of the invention it is proposed that at least one ethyl vinyl acetate copolymer is a random copolymer, and, in particular, most preferably a random copolymer that does not contain, apart from the comonomers ethene and vinyl acetate, any other comonomer. Such ethyl vinyl acetate copolymers have proven to be particularly suitable in terms of preventing curling and setting a suitable viscosity of the coating composition.

Surprisingly, it has been shown in the context of the present invention that the proportion of vinyl acetate in the at least one ethyl vinyl acetate copolymer influences not only the viscosity of the coating composition, but also the extent to which the substrate, coated with said coating composition, will curl. In this respect it has proven to be advantageous that the proportion of the vinyl acetate in the at least one ethyl vinyl acetate copolymer of the coating composition is in the range of from 15 to 80% by weight, more preferably in the range of more than 18 to 60% by weight, in particular, preferably in the range of from 20 to 50% by weight and most preferably in the range of from 25 to 40% by weight.

In accordance with an additional, particularly preferred embodiment of the present invention, the coating composition contains at least one ethyl vinyl acetate copolymer having a melt index of from 10 to 500 g/10 min., preferably from 15 to 150 g/10 min. and, in particular, preferably from 20 to 50 g/10 min., where said melt index was measured at 190° C. and at a test weight of 2.16 kg. Ethyl vinyl acetate copolymers of this type have a sufficiently high molecular weight, so that an emission of said copolymers from the coating composition is reliably avoided even after a long period of time; and said copolymers lend themselves superbly to setting an optimal viscosity of the coating composition.

In accordance with the present invention, the proportion of the at least one ethylene vinyl acetate copolymer in the coating composition is 15 to 80% by weight. Smaller amounts of the ethylene vinyl acetate copolymer lead to an insufficient setting of the viscosity and to an inadequate reduction in curling, whereas higher amounts do not have any further advantages in this respect, but rather have an adverse impact on the application properties of the coating composition. In view of the aforesaid, it is preferred that the proportion of the at least one ethyl vinyl acetate copolymer in the coating composition is 18 to 60% by weight, in particular, preferably 20 to 50% by weight and most preferably 25 to 40% by weight.

In accordance with the present invention, the coating composition contains 0.1 to 30% by weight of at least one hydrocarbon resin. The addition of the hydrocarbon resin contributes significantly to a suitable viscosity of the coating composition and, in combination with the lubricant, the ethylene vinyl acetate copolymer and the wax, to a reduction in the degree of curling of the substrate that is coated with said coating composition. Furthermore, the hydrocarbon resin is important for setting a suitable hardness, thermal stability, blocking tendency and a suitable softening point.

In this respect good results are obtained, especially if at least one resin is used in the coating composition, where said at least one resin is selected from the group consisting of aliphatic resins, cycloaliphatic resins, aromatic resins and any mixture of two or more of the aforementioned compounds. Furthermore, it is preferred to provide a corresponding resin with a low residual monomer content in the coating composition, i.e., preferably a resin with a corresponding residual monomer content of less than 1,000 ppm, more preferably of less than 100 ppm and most preferably of not more than 10 ppm. This aspect helps to prevent the emission of undesirable substances and unpleasant odors.

In a further development of the invention it is proposed that the coating composition contains at least one resin that is selected from the group consisting of aliphatic resins, cycloaliphatic resins, polystyrene resins, poly methyl styrene resins and any mixture of two or more of the aforementioned compounds, preferably a cycloaliphatic resin, an indene-coumarone resin and/or a poly methyl styrene resin, in particular, preferably a dicyclopentadiene resin and/or a poly alpha methyl styrene resin and most preferably a dicyclopentadiene resin or an indene-coumarone resin having a weighted average molecular weight of from 200 to 1,000 g/mol and/or a poly alpha methyl styrene resin having a weighted average molecular weight of from 500 to 2,000 g/mol. Such resins have proven to be particularly suitable in terms of preventing curling and setting a suitable viscosity of the coating composition.

In accordance with the present invention, the proportion of the at least one hydrocarbon resin in the coating composition is 0.1 to 30% by weight. Smaller amounts of hydrocarbon resin lead to an insufficient effect of the hydrocarbon resin, whereas higher amounts do not have any further advantages in this respect, but rather have a negative impact on the application properties of the coating composition. In view of the aforesaid, it is preferred that the proportion of the at least one hydrocarbon resin in the coating composition is 1 to 20% by weight, more preferably 2 to 15% by weight and, in particular, preferably 5 to 13% by weight.

In accordance with the present invention, the coating composition contains 0.1 to 20% by weight of at least one wax. The addition of the wax helps to set a suitable viscosity of the coating composition and controls the “open time”, which is an important factor in the coating process. Furthermore, the wax is also important for setting a suitable hardness, thermal stability, blocking tendency and a suitable softening point. The amount of the wax is preferably less than the amount of the hydrocarbon resin.

Good results are obtained, especially if the at least one wax, which is contained in the coating composition, is a hydrocarbon wax and is, in particular, preferably a saturated hydrocarbon wax.

In accordance with the present invention, the proportion of the at least one wax in the coating composition is 0.1 to 20% by weight. Smaller amounts of wax lead to an insufficient effect of the wax, whereas higher amounts do not have any further advantages in this respect, but rather have an adverse effect on the application properties of the coating composition. In view of the aforesaid, it is preferred that the proportion of the at least one wax in the coating composition is 0.5 to 15% by weight, in particular, preferably 1 to 10% by weight and most preferably 2 to 8% by weight.

In accordance with the present invention, the coating composition contains 0.1 to 80% by weight of at least one filler. The addition of the filler makes it possible to reduce the flammability of the coating composition even without the addition of special flame retardants. Moreover, an increased amount of filler also promotes the heat transfer of the coating composition, an aspect that is important not only for the coating process, but also for the printing, foaming and embossing process. In addition, fillers are slightly volatile, so that the addition of said fillers helps to reduce or, more specifically, to prevent the emission of undesirable substances and unpleasant odors of the coating composition.

In this respect good results are achieved, especially if the coating composition contains at least one inorganic filler as a filler.

The inorganic filler is selected preferably from the group consisting of calcium carbonate, mixtures of calcium carbonate and magnesium carbonate, aluminum hydroxide, barium sulfate and any mixture of two or more of the aforementioned compounds. The coating composition contains, in particular, preferably calcium carbonate or a mixture of calcium carbonate and magnesium carbonate, in particular, in the form of dolomite.

In addition, it is also advantageous that the coating composition contains, in addition to one or more inorganic fillers, already expanded hollow microspheres as a filler. These organic fillers are also referred to as light fillers and can be used, in particular, to reduce the specific weight of the fillers or, more specifically, to increase the specific volume. In this case special preference is given to expanded hollow polymer spheres.

Without being bound by a scientific theory, it does appear that the very high specific volume of these inorganic/organic fillers has been achieved by the interaction between the polymer material and the inorganic fillers.

In accordance with the present invention, the proportion of the at least one filler in the coating composition is 0.1 to 80% by weight. Smaller amounts of filler lead to an inadequate impact on the effects mentioned above, whereas higher amounts do not have any further advantages in this respect, but rather have an adverse effect on the application properties of the coating composition. In view of this aspect, it is preferred that the proportion of the at least one filler in the coating composition is 10 to 80% by weight, preferably 20 to 70% by weight, in particular, preferably 30 to 60% by weight and most preferably 40 to 55% by weight.

In a further development of the invention it is proposed that the sum of the proportions of the ethyl vinyl acetate copolymer and the filler in the coating composition is 25 to 99% by weight, more preferably 40 to 98% by weight, in particular, preferably 60 to 97% by weight and most preferably 70 to 96% by weight.

The weight ratio of ethylene vinyl acetate copolymers of the component a) to filler is in the range of from 80:20 to 10:90, preferably from 70:30 to 20:80, in particular, from 60:40 to 30:70.

In particular, for the production of a structural foam wallpaper, it is provided in accordance with an additional, particularly preferred embodiment of the present invention that, in addition to the components a) to e) described above, the coating composition also contains at least one blowing agent as component f). In principle, any blowing agent can be used in the context of the present invention, whereas good results are achieved, in particular, with blowing agents that are selected from the group consisting of hollow microspheres, metal carbonates, azodicarbonamide, oxybis benzenesulfonyl hydrazide, C₃₋₁₀ alkanes and/or mixtures of two or more of the aforementioned compounds.

The coating composition contains preferably hollow microspheres that are filled with a C₃-10 alkane, preferably with a C₃₋₈ alkane and, in particular, preferably with isooctane as a blowing agent. The hollow microspheres or, more specifically, the microcapsules, which are used as a blowing agent, do not expand until just before the hot embossing apparatus.

The amount of blowing agent in the coating composition should be adjusted as a function of the desired degree of foaming. In particular, it has proven to be advantageous for the proportion of the blowing agent in the coating composition to be 0.1 to 20% by weight, in particular, preferably 0.25 to 10% by weight and most preferably 0.5 to 5% by weight, such as, in particular, 2 to 4% by weight (such as about 2% by weight). In this way an optimal ratio of the achievable foam height to the necessary mechanical strength is obtained.

Furthermore, it is provided in accordance with a further embodiment of the present invention that the coating composition contains, in addition to the components a) to e) described above and optionally the component f), 0.05 to 2% by weight of at least one antioxidant as the component g).

Suitable antioxidants are well-known to the person skilled in the art. Preference may be given to the use of antioxidants that exhibit a low volatility and, as a result, can lead to a further reduction in the output of undesirable emission. In this case amine-free antioxidants are used, in particular. Therefore, the antioxidants are selected preferably from the group consisting of sterically hindered phenols, lactones, such as, in particular, benzofuran-2-one derivatives, sterically hindered phosphites or mixtures thereof.

Examples of sterically hindered phenols are pentaerythritol tetrakis(3-(3,5-di-tert-butyl-4-hydroxyphenyl)propinate, octadecyl-3-(3,5-di-t-butyl-4-hydroxyphenyl)propinate, 3,5-bis-(1,1-dim ethylethyl-4-hydroxy-C7-C9-alkyl branched esters, ethylene(bisoxyethylene(bis-(3-(5-t-butylhydroxy-4-tolyl)propionate. Examples of lactones, in particular, benzofuran-2-one derivatives are described in the documents EP 1291384 and DE 19618786.

Sterically hindered phosphites, such as tris(2,4-di-t-butylphenyl)phosphite, are described, for example, in the document EP 905180.

Furthermore, the coating composition can contain, depending on the application, 0 to 30% by weight of at least one additive, such as, for example, a flame retardant and/or colorant, such as titanium dioxide, as the component h).

In accordance with a first, very highly preferred embodiment of the present invention the coating composition contains:
a) 20 to 50% by weight of a random ethyl vinyl acetate copolymer that does not contain, apart from the comonomers ethene and vinyl acetate, any other comonomer,
b) 1 to 20% by weight of a hydrocarbon resin that is selected from the group consisting of aliphatic resins, cycloaliphatic resins, indene-coumarone resins, polystyrene resins, poly methyl styrene resins and any mixture of two or more of the aforementioned compounds,
c) 1 to 15% by weight of at least one polyolefin wax,
d) 20 to 70% by weight of a filler that is selected from the group consisting of calcium carbonate, mixtures of calcium carbonate and magnesium carbonate, aluminum hydroxide, barium sulfate and any mixture of two or more of the aforementioned compounds, and
e) 0.05 to 5% by weight of a carboxylic acid amide of the general formula (I) and/or a salt thereof, where R₁ is a C₁₀₋₂₄ alkyl group; and R₂ and R₃ are the same or different from each other and denote hydrogen or a substituted or unsubstituted alkyl amide group,
   where the sum of all the components is 100% by weight.

In accordance with a second, very highly preferred embodiment of the present invention the coating composition contains:
a) 25 to 40% by weight of a random ethyl vinyl acetate copolymer that does not contain, apart from the comonomers ethene and vinyl acetate, any other comonomer, wherein the proportion of the vinyl acetate in the ethyl vinyl acetate copolymer is in the range of more than 18 to 60% by weight; and the ethyl vinyl acetate copolymer has a melt index of from 15 to 150 g/10 min., said melt index being measured at 190° C. and at a weight of 2.16 kg,
b) 2 to 15% by weight of a dicyclopentadiene resin having preferably a weighted average molecular weight of 200 to 1,000 g/mol and/or a poly alpha methyl styrene resin having preferably a weighted average molecular weight of from 500 to 2,000 g/mol, 1 to 10% by weight of a polyethylene wax having preferably a weighted average molecular weight of from 500 to 2,000 g/mol,
d) 30 to 60% by weight of calcium carbonate or a mixture of calcium carbonate and magnesium carbonate, preferably dolomite, and
e) 0.1 to 2% by weight of a carboxylic acid amide of the general formula (I) and/or a salt thereof, where R₁ is a C₁₅₋₂₀ alkyl group; and R₂ denotes a substituted or unsubstituted alkyl amide group; and R₃ denotes hydrogen,
   where the sum of all the components is 100% by weight.

In the two aforementioned very highly preferred embodiments of the present invention the coating composition can additionally contain, as the component f), 0.05 to 5% by weight of a blowing agent that is selected preferably from the group consisting of hollow microspheres, metal carbonates, azodicarbonamide, oxybis benzenesulfonyl hydrazide, C3-10 alkanes and/or mixtures of two or more of the aforementioned compounds.

As described above, it is a particular advantage of the present invention that no chlorine-containing polymer has to be added to the coating composition in order to obtain the desired properties. Therefore, in accordance with the present invention it is particularly preferred that the coating composition does not contain any chlorine-containing polymer.

In a further development of the invention it is proposed that the coating composition does not contain, apart from the components a) to h) described above, any other compound(s). That means that the coating composition consists of the components a) to e), optionally f), optionally g) and optionally h).

Another subject matter of the present invention is a coated substrate and, in particular, a coated wall, floor and ceiling covering, where said coated substrate or wall, floor and ceiling covering comprises a web-shaped substrate that is coated with a coating composition, described above, at least in sections on at least one of its two sides. The web-shaped substrate is coated with the above described coating composition preferably over the entire surface of one of its two sides.

The present invention is suitable, in particular, for coated substrates, where the substrate is selected from the group consisting of wood, wood components, wood materials, papers, plastics, organic fibers, synthetic fibers, mineral compounds, metals, two dimensional textile products and combinations of two or more of the aforementioned substrates.

The substrate of the coated substrate is preferably a two dimensional textile product or a paper and preferably a non-woven fabric.

Furthermore, the present invention relates to a method for producing a coated substrate and, in particular, a coated wall, floor and ceiling covering, wherein said method comprises the following process steps:

i. providing a web-shaped substrate and preferably a wallpaper,
ii. providing a coating composition described above,
iii. applying the coating composition to at least one section of at least one side of the substrate and preferably over the entire surface of one of the two sides of the substrate,
iv. curing, solidifying and/or cooling the coating composition,
v. optionally printing on the coating composition
vi. optionally thermoforming the coating composition,
vii. optionally laminating/pasting a thin film

One particular advantage of the coating composition of the present invention is that it can be printed with all standard printing inks and by means of all conventional printing techniques. Therefore, the coating composition can be printed on the coated substrate, in particular, with aqueous printing inks, preferably by means a printing process selected from gravure, flexographic, inkjet or screen printing processes.

The printed substrate can be thermoformed, in particular, in the method for producing the coated substrate.

In order to apply the coating compositions to a web-shaped substrate, it may be advantageous to heat the coating composition in the range of from 50 to 200° C., preferably from 60 to 180° C. The setting of the temperature makes possible a suitable coating viscosity and can make it easier to process the coating compositions.

Finally, the printed substrate can be covered with a protective layer and/or with a thin film as the last step.

The coating compositions are used preferably for the production of a wall covering, in particular, a wallpaper.

It has been found that in another aspect of the invention, in particular, those coating compositions of the invention are advantageous, in which at least one ethylene vinyl acetate copolymer (A), at least one acrylate copolymer (B), at least one polyvinyl acetate copolymer (C) or mixtures thereof (D) are used in a dispersion medium as a dispersion

Therefore, in one particular aspect the invention relates to coating compositions for the production of a coated wall, floor and ceiling covering, in particular, wallpapers, wherein said coating compositions contain the following components:
a) 2 to 80% by weight of at least one ethylene vinyl acetate copolymer (A), at least one acrylate copolymer (B), at least one polyvinyl acetate copolymer (C) or mixtures thereof (D),
b) 0.1 to 80% by weight of at least one filler,
c) 0.0 to 20% by weight of optionally at least one wax,
d) 0.0 to 20% by weight of optionally at least one lubricant,
e) 0.0 to 10% by weight of optionally at least one polymer or copolymer that contains at least one group that is selected from the group consisting of ester, melamine, urea, formaldehyde, ether, epoxy, carbamate, acrylic acid, methyl methacrylate or mixtures thereof, and
f) 0.0 to 10% by weight of optionally a blowing agent,
   where the sum of all the components is 100% by weight, characterized in that there is at least one copolymer of the component a) in a dispersion medium.

The above definitions apply mutatis mutandis to this particular aspect of the invention, unless it is explicitly stated otherwise below.

The term “dispersion” denotes for the purpose of the invention a heterogeneous mixture consisting of a dispersion medium, in which at least one copolymer (A) to (D) of the component a) is dispersed, and a dispersion medium, in which at least one copolymer of the component a) is dispersed.

The dispersion medium may be solid or liquid and should be selected in such a way that the compound to be dispersed does not dissolve in the dispersion medium.

Suitable dispersion mediums for the at least one ethylene vinyl acetate copolymer are known to the person skilled in the art and can be selected, for example, from water, aliphatic or cyclic hydrocarbons, alkyl alcohols, glycols, alkylene diamines, aqueous salt solutions, aqueous ammonia solutions, hydrogen peroxide, formaldehyde, phosphoric acid, formic acid, sodium or potassium hydroxide or aqueous solutions of sodium hydroxide or potassium hydroxide or mixtures thereof.

The use of aqueous polymer dispersions during a manufacturing process that includes one or more drying or heating steps may be preferred, as compared to the addition of organic dispersion mediums, since there is a reduced health risk for the environment and the user.

Therefore, the dispersion medium in a preferred embodiment is selected from the group consisting of water, aqueous salt solutions or mixtures thereof. The dispersion medium is, in particular, water.

Therefore, the copolymers (A) to (D) of the component a) may be present as an aqueous polymer dispersion in a particularly advantageous embodiment.

Good results are obtained, in particular, at a proportion of water in the range of from 1 to 90% by weight, preferably from 10 to 70% by weight, more preferably from 15 to 60% by weight, in particular, preferably from 20 to 50% by weight, in particular from 25 to 45% by weight.

Preferably the copolymers of the component a) are dispersed by means of a mixing apparatus, preferably a dissolver stirrer, a rotor/stator mixer or a comparable apparatus, all of which allow a vigorous dispersion of the mixture.

The additional components can be brought into contact with the at least one copolymer, if desired, while stirring (i.e., dispersing). The configuration of a dispersion can enhance the uniform distribution of the individual components of the coating composition and, in so doing, can have an advantageous effect on the quality of the resulting product.

Such inventive coating compositions that contain aqueous polymer dispersions also offer the advantage that they can be solidified by simply drying or evaporating without generating any noxious fumes.

Moreover, said coating compositions of the invention are easy to process and exhibit very good flow properties. Therefore, in one particularly advantageous embodiment the invention relates to coating compositions, wherein the copolymers of the component a) are present in an aqueous dispersion.

Good results are achieved, when at least two copolymers of the component a) are used to produce the coating composition. In this case the at least two copolymers can also be selected from the same group of the copolymers. Thus, for example, both copolymers may be acrylate copolymers (B). Similarly it is also possible to combine at least two different copolymers, for example, ethylene vinyl acetate copolymers (A) with acrylate copolymers (B) and/or polyvinyl acetate copolymers (C). In this context all conceivable permutations are included.

In addition, it has been found that particularly advantageous results are obtained, when the glass temperature (Tg) of the at least two copolymers of the component a) is not the same.

The term “glass temperature” (Tg) denotes the softening point, at which the chain segments of the polymer begin to move and can perform translational movements. The glass temperature of a polymer or a copolymer is influenced by various factors. One factor is the degree of branching of the polymers or copolymers. In the case of the copolymers the glass temperature is also significantly influenced by the weight ratio of the cornonomers that are used.

In this case preference is given, in particular, to coating compositions that contain the copolymers (A) to (D) of the component a), where the glass temperature (Tg) of said copolymers is in the range of from −100 to 200° C., preferably from −100 to 100° C., more preferably from −70 to 100° C., in particular, preferably from −50 to 20° C.

If the coating compositions of the present invention contain more than one copolymer of the component a), then the relative difference in the respective glass temperatures is at least 5° C., preferably at least 10° C., in particular, preferably at least 15° C.

In a further development of the invention it is proposed that the solid content of the at least one copolymer dispersion of the component a) is no more than 80% by weight; preferably the solid content is in the range of from 20 to 70% by weight, in particular, preferably in the range of from 40 to 60% by weight, in particular, in the range of from 45 to 55% by weight.

Furthermore, it is provided in another embodiment of the invention that the weight ratio of the copolymers of the component a) to the filler is in the range of from 99:1% by weight to 50:50% by weight, preferably from 95:5% by weight to 60:40% by weight, in particular, preferably from 90:10% by weight to 70:30% by weight.

It may be advantageous in another embodiment of the invention to add optionally an additional polymer or copolymer as the component e) to the coating compositions. These polymers or copolymers may be present in a dispersion medium, in particular, water, as already for the copolymers (A) to (D) of this aspect. In a particularly preferred embodiment these polymers or copolymers contain at least one group that is selected from the group consisting of ester, melamine, urea, formaldehyde, ether, epoxy, carbamate, acrylic acid, methyl methacrylate or mixtures thereof. The results are accordingly polymers or copolymers, such as, for example, polyesters, amino plastics, polyethers, polyurethanes, polyacrylates, polymethyl methacrylates or mixtures thereof.

The term “polyester” denotes for the purpose of the invention compounds that consist of monomer building blocks that contain at least one ester group. “Esters” are groups of substances that are produced by the reaction of an acid and an alcohol with the elimination of water. Organic acids or inorganic acids may be used as the acids. Examples of organic acids are, in particular, carboxylic acids or amino acids. For example, compounds, such as phosphoric acid, sulfuric acid, boric acid or carbonic acid, are regarded as inorganic acids. The term “alcohols” denotes all compounds that have one or more hydroxy groups (—O—H) and are bound to aliphatic carbon atoms.

“Amino plastics” belong to the group of synthetic resins and are produced by a repeatedly cycling condensation reaction (i.e., polycondensation) of carbonyl compounds (—C═O(R)) and compounds having at least one NH group. Preference is given to the use of formaldehyde as a carbonyl compound. Preferred examples of compounds that carry the NH groups are melamine, urea or dicyandiamide. This means, for example, for the amino plastics urea resins, melamine resins or dicyandiamide resins.

In this case the term “melamine” includes, in addition to the unsubstituted 2,4,6-triamino-1,3,5-triazine, also substituted 2,4,6-triamino-1,3,5-triazine.

The term “polyethers” describes compounds that denote at least one ether group, an oxygen atom that carries two hydrocarbon radicals (R—O—R). The respective hydrocarbon radicals can be the same or different from each other and can contain aliphatically unsaturated, monounsaturated or polyunsaturated hydrocarbons that can be chain shaped or also cyclical. The polyethers may contain at least one epoxy in terminal position and in this case are also referred to as “epoxy resins”.

“Polyurethane” belongs to the group of synthetic resins and denotes compounds that consist of several monomer building blocks that carry at least one carbamate group. “Carbamates” are salts and esters of carbamic acids (RN—COOH). The esters are also referred to as “urethanes”.

For the purpose of the invention “polyacrylate” denotes the polymerization product consisting of two esters of the acrylic acid (i.e., acrylic acid ester) and/or of the methacrylic acid.

In a further development of this aspect of the invention a wax can be added optionally as component c) to the coating compositions of the present invention. The waxes are defined as described herein. However, particularly good results are obtained in the case of polyolefin waxes and, in particular, the polyethylene waxes, when a polyethylene wax having a weighted average molecular weight of from 2,000 g/mol to 30,000 g/mol, preferably from 5,000 g/mol to 20,000 g/mol, in particular, preferably from 7,000 g/mol to 12,000 g/mol is added.

Furthermore, in order to adapt to the practical requirements, additional standard auxiliary substances can be added to the coating compositions in the customary amounts as the components h) and i), which are defined as described herein. If the coating compositions contain, in addition to the components a) to f), the additional auxiliary substances h) and/or i), then the sum of the components a) to i) is also 100% by weight in this aspect.

Furthermore, the invention relates to a method for producing a coating composition, wherein said method comprises the following steps:
(i) providing a coating composition, which is defined as herein;
(ii) dispersing the coating composition in water.

Furthermore, the present invention relates to a method for producing a coated substrate and, in particular, a coated wall, floor and ceiling covering, wherein said method comprises the following process steps:

i. providing a web-shaped substrate and preferably a wallpaper,
ii. providing an above-described coating composition that is characterized by the fact that there is at least one copolymer of the component a) in a dispersion medium, which is defined as described herein,
iii. applying the coating composition to at least one section of at least one side of the substrate and preferably over the entire surface of one of the two sides of the substrate,
iv. drying the coating composition,
v. optionally printing on the coating composition,
vi. optionally thermoforming the coating composition,
vii. optionally laminating/pasting a thin film.

The drying process of the described coating compositions can be carried out, for example, at room temperature by simply evaporating the dispersion medium. The drying process of the coating composition is carried out preferably in such a way that after the drying process there is a residual moisture of less than 10% by weight, preferably of less than 5% by weight, in particular, of less than 3% by weight.

In a particularly preferred embodiment of this aspect the drying process of the coating composition takes place in a range of from 80 to 220 C, ° preferably from 90 to 200° C., in particular, preferably from 95 to 180° C.

In this case the temperature range of the drying process is adjusted preferably in such a way that during the drying process no expansion of the microspheres, which are used as the blowing agent, has taken place yet.

Preferred embodiments may have the following formulations:

### EXAMPLE A

| | | Glass | Proportion in the |
|---|---|---|---|
| Class of | | Temperature | Composition |
| Compound | Function | (Tg in ° C.) | (% by weight) |
| Copolymer | Copolymers (A)-(D) | −50 to +20 | 20 to 80 |
| dispersion | | | |
| Inorganic | Filler | | 5 to 40 |
| filler | | | |
| Microspheres/ | Blowing agent | | 5 to 10 |
| Sodium | | | |
| hydrogen | | | |
| carbonate | | | |
| Other | Defoamer/Thickener/ | | 0.1 to 30 |
| auxiliary | Wetting agent/ | | |
| substances | Pigment/Plasticizer | | |

### EXAMPLE B

| | | Glass | Proportion in the |
|---|---|---|---|
| Class of | | Temperature | Composition |
| Compound | Function | (Tg in ° C.) | (% by weight) |
| Copolymer | Copolymers (A)-(D) | −30 to +15 | 30 to 60 |
| dispersion | | | |
| Inorganic | Filler | | 5 to 40 |
| Filler | | | |
| Fischer- | Wax | | 0.1 to 10 |
| Tropsch wax | | | |
| Microspheres | Blowing agent | | 1 to 10 |
| Other | Defoamer/Thickener/ | | 0.1 to 30 |
| auxiliary | Wetting agent/ | | |
| substances | Pigment/Plasticizer | | |

### EXAMPLE C

| | | Glass | Proportion in the |
|---|---|---|---|
| Class of | | Temperature | Composition |
| Compound | Function | (Tg in ° C.) | (% by weight) |
| Acrylate | Copolymer (B) | +11 | 35 to 40 |
| copolymer | | | |
| dispersion | | | |
| Ethylene | Copolymer (A) | +3 | 40 to 45 |
| vinyl acetate | | | |
| copolymer | | | |
| dispersion | | | |
| Calcium | Filler | | 10 to 15 |
| carbonate | | | |
| Microspheres | Blowing agent | | 5 to 10 |
| Other | Defoamer/Thickener/ | | 0.1 to 10 |
| auxiliary | Wetting agent/ | | |
| substances | Plasticizer/Pigment | | |

### EXAMPLE D

| | | Glass | Proportion in the |
|---|---|---|---|
| Class of | | Temperature | Composition |
| Compound | Function | (Tg in ° C.) | (% by weight) |
| Acrylate | Copolymer (B) | +11 | 35 to 40 |
| copolymer | | | |
| dispersion | | | |
| Acrylate | Copolymer (B) | −25 | 40 to 45 |
| copolymer | | | |
| dispersion | | | |
| Calcium | Filler | | 10 to 15 |
| carbonate | | | |
| Microspheres | Blowing agent | | 5 to 10 |
| Other | Defoamer/Thickener/ | | 0.1 to 10 |
| auxiliary | Wetting agent/ | | |
| substances | Plasticizer/Pigment/ | | |

### Class E

| | | Glass | Proportion in the |
|---|---|---|---|
| Class of | | Temperature | Composition |
| Compound | Function | (Tg in ° C.) | (% by weight) |
| Acrylate | Copolymer (B) | +11 | 70 to 80 |
| copolymer | | | |
| dispersion | | | |
| Polyvinyl | Hydrocarbon resin | | 1 to 5 |
| alcohol | | | |
| Dolomite | Inorganic filler | | 0.1 to 10 |
| Expanded | Organic filler | | 0.1 to 5 |
| microspheres | | | |
| Microspheres | Blowing agent | | 5 to 10 |
| Other | Defoamer/Thickener/ | | 0.1 to 20 |
| auxiliary | Wetting agent/ | | |
| substances | Plasticizer/Pigment | | |

### Class F

| | | Glass | Proportion in the |
|---|---|---|---|
| Class of | | Temperature | Composition |
| Compound | Function | (Tg in ° C.) | (% by weight) |
| Polyvinyl | Copolymer (B) | 0 | 0 to 80 |
| acetate | | | |
| copolymer | | | |
| dispersion | | | |
| Amino | Polymer dispersion | | 2 to 5 |
| plastics | | | |
| Dolomite | Inorganic filler | | 0.1 to 10 |
| Expanded | Organic filler | | 0.1 to 5 |
| microspheres | | | |
| Microspheres | Blowing agent | | 5 to 10 |
| Other | Defoamer/Thickener/ | | 0.1 to 20 |
| auxiliary | Wetting agent/ | | |
| substances | Plasticizer/Pigment | | |

The present invention is explained in more detail below by means of two examples that describe, but do not restrict the invention.

### EXAMPLES

Three coating compositions of the present invention were mixed together according to the formulations summarized in the table below.

| | Example 1 | Example 2 | Example 3 |
|---|---|---|---|
| Component | (% by weight) | (% by weight) | (% by weight) |
| EVA | 40 | 28 | 30 |
| DCPD resin | 12 | | 8 |
| Alpha methyl | | 8 | |
| styrene resin | | | |
| PE wax A | 3 | | |
| PE wax B | | 5 | 3 |
| Carboxylic | 0.5 | 0.3 | |
| acid amide | | | |
| Dolomite | 43.5 | 54.7 | 58 |
| Blowing agent | 1 | 4 | 0.0 |
| Metal soap | | | 1.0 |

With respect to the raw materials the following information may be added:
EVA: copolymer of ethylene and vinyl acetate with a vinyl acetate content of 33% by weight, based on the copolymer
DCPD resin: dicyclopentadiene resin
Carboxylic acid amide: octadecanamide
Blowing agent: microcapsules containing isooctane
Metal soap: zinc stearate

The viscosity of the coating compositions, produced in this way, was measured in a rotating mode (plate/plate) at 140° C., using a “Physics MCR 301” rheometer from the company Anton Paar; and the storage modulus was measured in an oscillating mode (plate/plate) at 20° C. in GPa, also using a “Physics MCR 301” rheometer from the company Anton Paar.

In addition, the curling behavior of a substrate, coated with the corresponding coating composition, was measured. For this purpose the coating compositions of the examples were melted in a first step; and the melts, obtained in this way, were uniformly applied to a non-woven wallpaper in two different layer thicknesses of 200 μm and 100 μm. After cooling, the flatness of the coated substrates, produced in this way, was determined.

The corresponding results are summarized in the table below. FIG. 1 shows the photographic comparison with a wallpaper made in accordance with the prior art.

The viscosity of the coating compositions, produced in this way, was measured in a rotating mode (plate/plate) at 140° C., using a “Physics MCR 301” rheometer from the company Anton Paar; and the storage modulus was measured in an oscillating mode (plate/plate) at 20° C. in GPa, also using a “Physics MCR 301” rheometer from the company Anton Paar.

| | Example 1 | Example 2 | Example 3 |
|---|---|---|---|
| Property | (% by weight) | (% by weight) | (% by weight) |
| Curling | Not significant | Not significant | Not significant |
| Viscosity 140° C. | 90,000 | 200,000 | 260,000 |
| (mPa · s) | | | |
| Storage modulus G′ | 12 | 9 | 13 |
| 20° C. (GPa) | | | |

These examples show that the coating compositions of the present invention are easy to process using the wall adhesion technique and exhibit properties that are suitable for wall, floor and ceiling coverings.

1. Coating composition for the production of a coated substrate and, in particular, for the production of a coated wall, floor and ceiling covering, said coating composition containing:
a) 15 to 80% by weight of at least one ethylene vinyl acetate copolymer,
b) 0.1 to 30% by weight of at least one hydrocarbon resin,
c) 0.1 to 20% by weight of at least one wax,
d) 0.1 to 80% by weight of at least one filler,
e) 0.01 to 20% by weight of at least one lubricant that is selected from the group consisting of carboxylic acid amides, fatty alcohols, metal soaps, complex esters and any mixture of two or more of the aforementioned compounds, and
f) 0.0 to 10% by weight of optionally a blowing agent,
where the sum of all the components is 100% by weight.

2. Coating composition for the production of a coated substrate and, in particular, for the production of a coated wall, floor and ceiling covering, said coating composition being obtained by combining the components:
a) 15 to 80% by weight of at least one ethylene vinyl acetate copolymer,
b) 0.1 to 30% by weight of at least one hydrocarbon resin,
c) 0.1 to 20% by weight of at least one wax,
d) 0.1 to 80% by weight of at least one filler,
e) 0.01 to 20% by weight of at least one lubricant that is selected from the group consisting of carboxylic acid amides, fatty alcohols, metal soaps, complex esters and any mixture of two or more of the aforementioned compounds, and
f) 0.0 to 10% by weight of optionally a blowing agent,
where the sum of all the components is 100% by weight.

3. Coating composition, as claimed in claim 1, characterized in that the at least one lubricant is a carboxylic acid amide of the general formula (I) and/or a salt thereof, 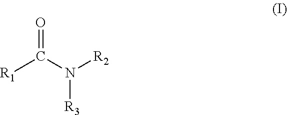
where
R₁ is a substituted or unsubstituted, straight-chain or branched alkyl group, a substituted or unsubstituted, straight-chain or branched alkenyl group, a substituted or unsubstituted, straight-chain or branched alkynyl group, a substituted or unsubstituted cycloaliphatic group, a substituted or unsubstituted aromatic group, a substituted or unsubstituted heterocyclic group, a substituted or unsubstituted alkoxy group, a substituted or unsubstituted alkoxy carbonyl group, a substituted or unsubstituted carboxyl group or a substituted or unsubstituted alkyl amide group; and R₂ and R₃ are the same or different from each other and denote hydrogen, a substituted or unsubstituted, straight-chain or branched alkyl group, a substituted or unsubstituted, straight-chain or branched alkenyl group, a substituted or unsubstituted, straight-chain or branched alkynyl group, a substituted or unsubstituted cycloaliphatic group, a substituted or unsubstituted aromatic group, a substituted or unsubstituted heterocyclic group, a substituted or unsubstituted alkoxy group, a substituted or unsubstituted alkoxy carbonyl group, a substituted or unsubstituted carboxyl group or a substituted or unsubstituted alkyl amide group.

4. Coating composition, as claimed in claim 1, characterized in that the at least one lubricant is a carboxylic acid amide of the general formula (I) and/or a salt thereof, where R₁ is a C₁₀₋₂₄ alkyl group and preferably a C₁₅₋₂₀ alkyl group; and R₂ and R₃ are the same or different from each other and denote hydrogen or a substituted or unsubstituted alkyl amide group.

5. Coating composition, as claimed in claim 1, characterized in that the carboxylic acid amide is a secondary bis amide.

6. Coating composition, as claimed in claim 1, characterized in that the at least one ethyl vinyl acetate copolymer is a copolymer that does not contain, apart from the comonomers ethene and vinyl acetate, any other comonomer.

7. Coating composition, as claimed in claim 1, characterized in that the proportion of the vinyl acetate in the at least one ethyl vinyl acetate copolymer is in the range of from 15 to 80% by weight, preferably in the range of more than 18 to 60% by weight, in particular, preferably in the range of from 20 to 50% by weight and most preferably in the range of from 25 to 40% by weight.

8. Coating composition, as claimed in claim 1, characterized in that at least one resin that is selected from the group consisting of aliphatic resins, cycloaliphatic resins, indene-coumarone resins, polystyrene resins, poly methyl styrene resins and any mixture of two or more of the aforementioned compounds, preferably a cycloaliphatic resin, an indene-coumarone resin and/or a poly methyl styrene resin, in particular, preferably a dicyclopentadiene resin, an indene-coumarone resin and/or a poly alpha methyl styrene resin and most preferably an indene-coumarone resin or a dicyclopentadiene resin having a weighted average molecular weight of from 200 to 1,000 g/mol and/or a poly alpha methyl styrene resin having a weighted average molecular weight of from 500 to 2,000 g/mol is contained as a hydrocarbon resin in the coating composition.

9. Coating composition, as claimed in claim 1, characterized in that the at least one wax is a polyolefin wax, preferably a polyethylene wax and, in particular, preferably a polyethylene wax having a weighted average molecular weight of from 500 to 2,000 g/mol.

10. Coating composition, as claimed in claim 1, characterized in that the inorganic filler is calcium carbonate or a mixture of calcium carbonate and magnesium carbonate, preferably dolomite.

11. Coating composition, as claimed in claim 1, characterized in that the proportion of the filler in the coating composition is 10 to 80% by weight, preferably 20 to 70% by weight, in particular, preferably 30 to 60% by weight and most preferably 40 to 55% by weight.

12. Coating composition, as claimed in claim 1, characterized in that the weight ratio of filler to ethylene vinyl acetate copolymers of the component a) is in the range of from 20:80 to 90:10, preferably from 30:70 to 80:20, in particular, from 40:60 to 70:30.

13. Coating composition, as claimed in claim 1, characterized in that the solid content in the coating composition is at least 15% by weight; preferably at least 30% by weight, in particular, preferably at least 40% by weight, in particular, at least 50% by weight.

14. Coating composition, as claimed in claim 1, characterized in that coating composition contains, in addition, as component f), at least one blowing agent that is selected preferably from the group consisting of hollow microspheres, metal carbonates, azodicarbonamide, oxybis benzenesulfonyl hydrazide, C₃₋₁₀ alkanes and/or mixtures of two or more of the aforementioned compounds.

15. Coating composition, as claimed in claim 1, characterized in that said coating composition contains:
a) 20 to 50% by weight of a random ethyl vinyl acetate copolymer that does not contain, apart from the comonomers ethene and vinyl acetate, any other comonomer,
b) 1 to 20% by weight of a hydrocarbon resin that is selected from the group consisting of aliphatic resins, cycloaliphatic resins, indene-coumarone resins, polystyrene resins, poly methyl styrene resins and any mixture of two or more of the aforementioned compounds,
c) 0.5 to 15% by weight of at least one polyolefin wax,
d) 20 to 70% by weight of a filler that is selected from the group consisting of calcium carbonate, mixtures of calcium carbonate and magnesium carbonate, aluminum hydroxide, barium sulfate and any mixture of two or more of the aforementioned compounds, and
e) 0.05 to 5% by weight of a carboxylic acid amide of the general formula (I) and/or a salt thereof, where R₁ is a C₁₀₋₂₄ alkyl group; and R₂ and R₃ are the same or different from each other and denote hydrogen or a substituted or unsubstituted alkyl amide group,
where the sum of all the components is 100% by weight.

16. Coated substrate and, in particular, a coated wall, floor and ceiling covering, said coated substrate comprising a web-shaped substrate that is coated at least in sections on at least one of its two sides with a coating composition, as claimed in claim 1.

17. Coated substrate, as claimed in claim 16, characterized in that the substrate is selected from the group consisting of wood, wood components, wood materials, papers, plastics, organic fibers, synthetic fibers, mineral compounds, metals, two dimensional textile products and combinations of two or more of the aforementioned substances.

18. Method for producing a coated substrate and, in particular, a coated wall, floor and ceiling covering, wherein said method comprises the following process steps:
(i) providing a web-shaped substrate, preferably a wallpaper,
(ii) providing a coating composition, as claimed in claim 1,
(iii) applying the coating composition to at least one section or at least one side of the substrate, preferably over the entire surface of one of the two sides of the substrate,
(iv) curing, solidifying and/or cooling the coating composition,
(v) optionally printing on the coating composition,
(vi) optionally thermoforming the coating composition,
(vii) optionally laminating/pasting a thin film.

19. Method for producing a coated substrate, as claimed in claim 18, characterized in that the application of the coating composition to the web-shaped substrate is carried out by a brushing process, spraying process or printing process, preferably by a printing process.

20. Method for producing a coated substrate, as claimed in claim 19, characterized in that the printing process is selected from the group consisting of screen printing processes, gravure printing processes, letterpress printing processes or inkjet printing processes, in particular, preferably, consisting of rotary screen printing processes, flat screen printing processes, rotogravure printing processes, flexographic printing processes or inkjet printing processes.

21. Method for producing a coated substrate, as claimed in claim 20, wherein the coating composition is printed with aqueous printing inks, preferably by a printing process selected from gravure, flexographic, inkjet or screen printing processes.

22. Use of a coating composition, as claimed in claim 1, for the production of a wall covering, in particular, a wallpaper.
